(19) United States
(12) Patent Application Publication
(10) Pub. No.: US 2008/0180340 A1
(43) Pub. Date: Jul. 31, 2008

(54) Waveguide Coupling Devices

(75) Inventors: Philip C. D. Hobbs, Briarcliff Manor, NY (US); Frank R. Libsch, White Plains, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/669,267

(22) Filed: Jan. 31, 2007

(51) Int. Cl. H01Q 13/00; G01B 9/02

(52) U.S. Cl. 343/785; 343/850; 343/700 MS; 356/477

(57) ABSTRACT

An optoelectronic device includes a substrate having a surface, a metallic coupling structure deposited on the surface of the substrate, the metallic coupling structure having a port and a waveguide interface portion with at least two waveguide interface portion sides, and a dielectric waveguide, the dielectric waveguide having a coupling interface portion deposited adjacent the at least two waveguide interface portion sides of the waveguide interface portion of the metallic coupling structure. It is possible to form high speed, CMOS-process-compatible, low power optical-electrical and electrical-optical conversion devices (i.e. optical detectors, modulators, and frequency mixer's) on the top of the semiconductor chip, after the rest of the wiling has been laid down.

### FIELD OF THE INVENTION

The present invention generally relates to the fields of optics and electronics and, more particularly, to waveguide coupling devices.

### BACKGROUND OF THE INVENTION

Metal antenna structures coupled to dielectric optical waveguides can be used for optical interconnections in high performance computers and routers. Since the high-frequency losses in wiring are becoming an increasingly important bottleneck in attainable aggregate bandwidth, such optical interconnects are of'significant interest. A great deal of present-day silicon photonics work is based on the use of crystalline silicon devices, such as electro-absorptive waveguide-PIN (p-type-intrinsic-n-type) diode structures and silicon photonic crystals. Integrating such devices with mainstream complementary metal oxide semiconductor (CMOS) processes is extremely difficult, however, which makes these devices of limited utility in real systems. One problem is that the silicon layer used for active devices is buried beneath several levels of metal and dielectric, so that optical access is very difficult. Another and perhaps more fundamental problem is that the processing requirements and materials constraints on the device layer are incompatible with those of most silicon photonics devices, making it difficult or impossible to fabricate silicon waveguide devices and high performance CMOS transistors on the same device level.

It would be desirable to overcome the deficiencies of prior art techniques.

### SUMMARY OF THE INVENTION

Principles of the present invention provide techniques for implementing waveguide coupling devices. One or mote inventive techniques allow formation of high speed, CMOS-process-compatible, low power optical-electrical and electrical-optical conversion devices (i.e. optical detectors, modulators, and frequency mixers) on the top of the semiconductor chip, after the rest of the wiring has been laid down.

In one aspect, an exemplary embodiment of an opto-electronic device includes a substrate having a surface, a metallic coupling structure deposited on the surface of the substrate, the metallic coupling structure having a port and a waveguide interface portion with at least two waveguide interface portion sides, and a dielectric waveguide the dielectric waveguide having a coupling interface portion deposited adjacent to the at least two waveguide interface portion sides of the waveguide interface portion of the metallic coupling structure.

In another aspect, an exemplary embodiment of an interferometer includes a substrate having a surface, a metallic coupling structure deposited on the surface of the substrate, the metallic coupling comprising a feed region and a waveguide interface portion with at least two waveguide interface portion sides, and a dielectric waveguide. The dielectric waveguide has a coupling interface portion deposited adjacent to the at least two waveguide interface portion sides of the waveguide interface portion of the metallic coupling structure, the dielectric waveguide being configured to split an incident wave in the waveguide into a first portion and a second portion. The first portion is guided by the metallic coupling structure, and the second portion is guided by the coupling interface portion of the waveguide. The dielectric waveguide is further configured to cause the first and second portions to recombine. In one or more exemplary embodiments, the arrangement just described can be achieved by having the dielectric waveguide cross over the waveguide interface portion of the metallic coupling structure, with the resulting vertical jog in the dielectric waveguide defining the coupling interface portion deposited adjacent the waveguide interface portion of the metallic coupling structure. The combination of the jog and the presence of the metal splits an incident wave in the waveguide into the first portion and the second portion.

In yet another aspect, an exemplary embodiment of an interferometer includes a substrate having a surface, a metallic coupling structure deposited on the surface of the substrate, the metallic coupling structure comprising a coplanar metallic transmission line and a waveguide interface portion, and a dielectric waveguide. The dielectric waveguide has a coupling interface portion deposited adjacent the waveguide inter face portion of the metallic coupling structure, the dielectric waveguide being configured to split an incident wave in the waveguide into a first portion and a second portion, the first portion being guided by the metallic coupling structure, the second portion being guided by the coupling interface portion of the waveguide, the dielectric waveguide being further configured to cause the first and second portions to recombine.

In still another aspect an exemplary embodiment of a nonlinear optical device includes an interferometer and an electro-optic material having a small-cross-section legion with a cross-section smaller than the cross section of a dielectric waveguide of the interferometer, the electro-optic material being juxtaposed with a coplanar metallic transmission line of the interferometer so as to concentrate a portion of an incoming optical wave into the small-cross-section region. The interferometer includes a substrate having a surface, a metallic coupling structure deposited on the surface of the substrate, the metallic coupling structure comprising a coplanar metallic transmission line having a waveguide interface portion, and a dielectric waveguide, the dielectric waveguide having a cross-section and having a coupling interface portion deposited adjacent the waveguide interface portion of the metallic coupling structure, the dielectric waveguide being configured to split an incident wave in the waveguide into a first portion and a second portion, the first portion being guided by the coplanar metallic transmission line, the second portion being guided by the coupling interface portion of the waveguide, the dielectric waveguide being further configured to cause the first and second portions to recombine.

These and other aspects of the invention will become apparent from the following detailed description of illustrative embodiments thereof, which is to be read in connection with the accompanying drawings

### BRIEF DESCRIPTION OF THE DRAWINGS

FIG. 1 shows an oblique view of a dielectric guide laid down adjacent an antenna structure, according to an embodiment of the invention;

FIG. 2 shows a cross section through the structure of FIG. 1, taken along line II-II thereof;

FIG. 3 shows a top view of an embodiment of an inventive device wherein a waveguide can be deposited first;

FIG. 4 is a cross section of the device of FIG. 3 taken along line IV-IV thereof;

FIG. 5 is an enlarged view of FIG. 4;

FIG. 6 is a top view of an embodiment employing an InGaAs detector;

FIG. 7 is a cross section of the device of FIG. 6 taken along line VII-VII thereof;

FIG. 8 is an enlarged view of FIG. 7;

FIG. 9 is a top view of a Mach-Zehnder embodiment;

FIG. 10 is a cross section of the device of FIG. 9 taken along line X-X thereof;

FIG. 11 is a bottom cross sectional view of the device of FIGS. 9 and 10 taken along line XI-XI of FIG. 10;

FIG. 12 is an enlarged view of FIG. 10 with FIG. 10 reproduced thereon for orientation purposes;

FIG. 13 is a top view of a Mach-Zehnder traveling wave embodiment;

FIG. 14 is a cross section of the device of FIG. 13 taken along line XIV-XIV thereof;

FIG. 15 is a bottom cross sectional view of the device of FIGS. 13 and 14 taken along line XV-XV of FIG. 14; and

FIG. 16 depicts and axial vertical cross-section of an inventive waveguide, showing splitting and recombination.

### DETAILED DESCRIPTION OF PREFERRED EMBODIMENTS

### 1. Polysilicon Saveguides

There has been some prior success in fabricating waveguides in polysilicon, amorphous silicon (a-Si), and amorphous silicon-hydrogen alloy (a-Si:H) laid down over SiO₂. Although these forms of deposited silicon are no longer common materials in CMOS processing, they are still available, and can be compatible with the later steps of back-end silicon processing (i.e. the steps in which the wiring is laid down), although polysilicon needs temperatures above 500 degrees Celsius for recrystallization, making the lower temperature amorphous materials more attractive. The main drawback of deposited silicon as a waveguide material is its high losses, stemming from dangling bonds at grain boundaries and from surface roughness. These losses are generally 6 to 100 dB/cm, a prohibitively large value for connections longer than a few hundred microns to a few millimeters. On the other hand, these guides are simple to fabricate, are highly routable, and have excellent field confinement in a small core, enhancing the strength of their interactions with antenna structures. Provided the device lengths can be kept short, deposited silicon is an attractive material for building waveguides on top of the back-end wiring layers on a CMOS chip.

### 2. Infrared Antennas

Antennas have been used at infrared and optical wavelengths for many years, beginning with the use of scanning tunnelling microscope (STM) in optical frequency chains, where the conical tip and flat substrate formed a discone antenna and the tunnelling gap functioned as the diode mixer. More recently, a few groups have been using lithographically-defined antennas to couple infrared radiation to metal-insulator-metal (MIM) tunnel junctions, bolometers, and infrared photoconductors such as HgCdₓTe₁₋ₓ Maxwell's equations are invariant with frequency, but the interactions of light with matter are not, because material properties are highly frequency dependent in general. In particular, at microwave frequencies and below, metals can be modelled as perfect conductors, and loss due to skin effect included as a first-order perturbation. At infrared frequencies and higher; this approximation breaks down, and there are no longer any “normal conductors”. Thus although the principles of antenna design do not change in going from microwaves to the infrared, their application becomes significantly more difficult as the wavelength becomes shorter, since the simple perturbation model no longer applies. The result is that antenna-coupled near-infrared devices have developed a well-deserved reputation for very low coupling efficiencies, on the order of 1%.

### 3. Waveguide-Coupled Antennas

The waveguide coupling structures of one or more embodiments of the invention resemble antennas in both appearance and function, although they are intended to couple to the guided mode of a dielectric waveguide rather than to fields in free space. Here we use the terms interchangeably, but the waveguide coupler application is in view throughout. An antenna at resonance behaves electrically as a resistor, thermally coupled to the incident radiation field. By classical equipartition, as well as from electromagnetic reciprocity, it can be shown that for a lossless antenna of unit efficiency, the product of its equivalent intercepted area and the solid angle of its radiation pattern is equal to λ²/2. The same is true of a single waveguide mode. A simple antenna such as a half-wave wire dipole receives from a solid angle of about 8 steradians, so its intercepted area is approximately λ²/16. Complicated antennas can achieve high directivity and large intercepted areas: a long Yagi-Uda antenna with a directivity of 17 dB (≈50) over isotropic receives from a solid angle of 4π/50≈25 si and an area of 25 λ². In coupling an antenna to a waveguide, the coupling efficiency is proportional to the overlap integral of the antenna pattern and the waveguide mode. Thus a low index-difference (low-Δ) waveguide whose area is large compared with λ²/2 requires an antenna that is electrically long (such as a Yagi-Uda). Fabricating such a device is challenging, because relatively small departures from the exact design dimensions can reduce the directivity significantly. Moreover, its efficiency is likely to be low, because of the large amount of very lossy metal encountered by the guided mode, and because of the tendency of large discontinuities (such as the first element of a multi-element metal antenna inside the waveguide core) to scatter most of the light out of a low-index-difference guide before strong interaction can occur. For a dielectric waveguide, matching to a small antenna requires that the mode field diameter be smaller than a wavelength, which requires high index contrast, as in the silicon-air and silicon core-SiO₂ cladding waveguide system High index contrast also forces more of the light to remain guided after first encountering the metal structures

### 4. Antenna-Waveguide Coupling Geometry

Good matching of antenna and mode field characteristics is useless unless the antenna can be placed so as to intercept the waveguide mode. Single-crystal silicon waveguides are typically made from silicon-on-insulator (SOI) wafers, in which a thin layer (perhaps 0.25 μm) of silicon overlies a 1-3 μm layer of SiO₂. Waveguides ale etched out of the silicon, producing silicon strip guides with an air top cladding, as ale commonly used in photonic crystal work. Such waveguides can have quite low losses for a high-Δ system, about 3 dB/cm, but they present very serious fabrication limitations Since the silicon guide sits on the SiO₂ layer, any antenna structure must then be fabricated on top of the waveguide. Achieving fine lithographic dimensions in optical lithography requites a very planar surface, however, because of the limited depth of focus of the high numerical aperture stepper lens. Thus laying the antenna down on top of the waveguide requires a planarization step, involving an SiO₂ overcoat and chemical-mechanical (chem-mech) polishing, and there is no simple way of getting the metal antenna into the interior of the waveguide, where the strongest coupling can occur

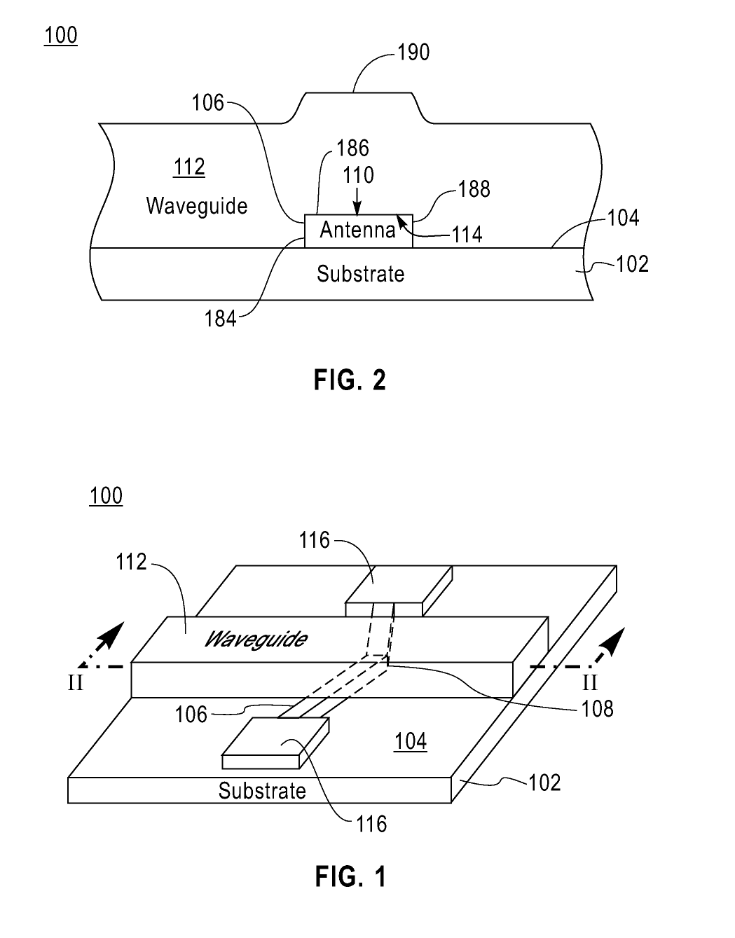

One or more exemplary embodiments of the invention use another approach, shown in FIG. 1 (discussed in greater detail below): fabricate the metal antennas 106 directly on the substrate 102, and deposit the silicon waveguide 112 over the top, using e g. evaporation or sputtering. Because the waveguide dimensions are significantly coarser than the antenna dimensions (by way of example and not limitation, typically 0.25 μm to 0.5 μm wide vs 0.07 μm to 0.15 μm for the fine antenna features), and the metal is usually thinner than the waveguide, depth-of-focus and thin-film step coverage issues are very much less serious in this geometry. Furthermore, since the guide has to wrap around the top of the antenna, the antenna intrudes into the high-field region, making good coupling easier to obtain, and also vertically displaces the part of the waveguide lying above it, forming a jog 190. FIG. 2 (also discussed in greater detail below) shows a cross-section of such a device, taken along line II-II in FIG. 1. Assuming perfectly-conducting metal, this device can do a good job of on-off modulation when the feed terminals are open- or short-circuited

### 5. Phase Cancellation (Mach-Zehnder Type) Modulation

Classical modulator technology used in telecommunications technology relies heavily on Mach-Zehnder interferometers, in which a phase modulation in one or both arms is transformed into an amplitude modulation via wave interference. Depending on their bias points, such modulators can be made to have very deep nulls in the off state, and so have a high on-off ratio that makes receiver design easier. Such devices tend to be large (millimetrs to centimetres) in size, making them unsuitable for high-density optical interconnections. One or more embodiments of the invention can effectively build on this approach, by creating interference fringes between the light propagating through the antenna and the light going around the top via the waveguide jog. Light in the feedpoint region travels very slowly, in a modified surface plasmon mode, so that there can be a few cycles phase difference between the two paths. Choosing the dimensions carefully results in a deep interference null in one state of the modulator, in a device only a few tenths of a micron long. This is true whether the modulator element coupled to the feedpoint region modifies primarily the amplitude, as in one or more tunnel junction embodiments, or primarily the phase, as in one or mote electro-optic embodiments. This principle can be used to make optical frequency mixers as well, using nonlinear electrical devices (e g. tunnel junctions) coupled to the feed region: the quadratic and higher order terms contributing to the current-voltage response of the junction produce mixing products at the sum and difference frequencies, as well as higher-order intermodulation products at the sums and differences of harmonics.

### 6. Out-of-Plane Coupling

Besides waveguides, detectors and modulators, a practical optical interconnection scheme needs input-output (I/O) structures to couple the light in and out of the waveguides. The traditional method, used in most optical fibre devices, is end-fire coupling, in which light is introduced into the waveguide along the waveguide axis, via a beam whose characteristics are matched to the waveguide mode. This can come from another waveguide or device very close by (butt coupling), or via free space propagation (lens coupling). This method is poorly suited to chip I/O, because the interconnection density is too high and the chip generally lies out of the plane of its mounting substrate A much more practical method is broadside coupling, in which light enters the waveguide from the side and is transferred to the waveguide mode by a coupling structure such as a mirror or a grating. For high-Δ waveguides such as Si—SiO₂, the waveguide must be fanned out first. Because of the high Δ, good fans can be made with very large angles (30 degrees is possible), so that the devices can be physically very compact, for example, about 10 μm×20 μm. Good detectors can be made in silicon, or with antenna-coupled tunnel junctions, but at present there is some challenge in finding a suitable candidate for a silicon light source. Thus a complete optical receiver can be made with a polysilicon broadside coupler, polysilicon waveguide, and an antenna-coupled tunnel junction detector. A similar transmitter can be made with two broadside couplers (one for the pump light and one for the output), a polysilicon waveguide between them, and an antenna-coupled tunnel junction modulator. Connections to the modulators and detectors can be made using ordinary metal studs from lower levels. These transmitters and receivers can be made entirely in back-end compatible materials such as metal, metal oxides, and low-temperature deposited silicon.

Because the devices are so compact, the entire interconnection can be made in an area comparable to that of a standard 50-μm solder ball connection, for example, using a total waveguide length of less than 200 μm. Such short waveguides have acceptably low losses even with 100-dB/cm waveguide attenuation; waveguide losses become negligible with good quality (10 dB/cm) waveguides.

Giving attention now to FIGS. 1 and 2, an exemplary optoelectronic device 100 includes a substrate 102 having a surface 104, and a metallic coupling structure 106 deposited on the surface 104 of the substrate 102. The metallic coupling structure 106 has a port 108 and a waveguide interface portion 110 with at least two waveguide interface portion sides; in the exemplary embodiment, there ale three sides 184, 186, 188 Also included is a dielectric waveguide 112. The dielectric waveguide 112 has a coupling interface portion 114 deposited adjacent to the at least two waveguide interface portion sides of the waveguide interface portion 110 of the metallic coupling structure 106. This forms a “jog” 190 in the waveguide 112. In one aspect, the metallic coupling structure 106 can be an antenna and the port 108 comprises a feed region of the antenna. Bond pads 116 can be provided. Note that as used herein, including the claims, “at least two waveguide interface portion sides” is intended to convey the concept that the waveguide wraps at least partway around the metallic coupling structure—it should be broadly construed to cover a metallic coupling structure that is curved in cross-section and may technically, in a geometric sense, not have two sides, as long as there is some partial wrapping around. Stated in another way, the waveguide wraps conformally around the exposed portion of the metal, optionally with a thin dielectric in between—thin in this context being defined as less than a cross-sectional dimension of the waveguide—displacing the waveguide in the direction perpendicular to the substrate surface.

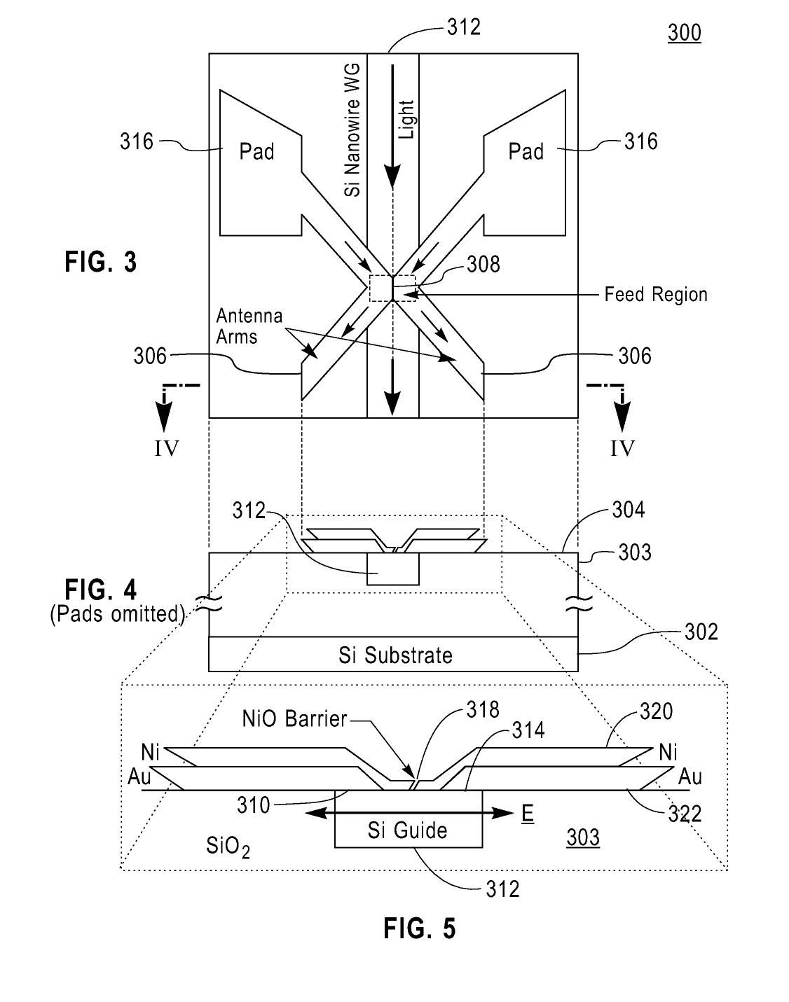

FIGS. 3-5 show a modified embodiment; elements similar to those in FIGS. 1 and 2 have received the same reference character incremented by two hundred. FIG. 3 shows a top view of the embodiment; FIG.4 is a cross section of the device of FIG. 3 taken along line IV-IV thereof, and FIG. 5 is an enlarged view of FIG. 4. The antenna 306 of this embodiment has two V-shaped arms arranged in the general shape of an X A nonlinear electrical impedance device 318 is configured to respond at an optical frequency, and is coupled to the port 308 of the metallic coupling structure. In the example of FIGS. 3-5, the nonlinear device is a tunnel junction formed by the Ni layer 320 and the NiO barrier. Note also Au layer 322 forming antenna aims 306 and oxide bottom cladding region 303 on substrate 302. It will be appreciated that in a mole general case, a Josephson junction or even (fox lower frequencies) a semiconductor junction could be used instead of the tunnel junction described above.

The dielectric waveguide 312 is a Silicon nanowire waveguide and comprises a core 312 formed of a material having a refractive index greater than about 2, preferably greater than exactly 2. The material comprises, for example, Silicon (defined to include polysilicon, amorphous silicon, amorphous silicon-hydrogen alloy, or crystalline silicon). An oxide encapsulant can be included adjacent the core, for example by chemical-vapor deposition or spin-on glass processes. Preferably, the core is formed from a non-glass material, since lower-index materials such as glass do not permit the inventive “jog,” as the index difference is too small to permit the light to turn sharply at the edge of the metal without escaping the waveguide.

An electrically variable impedance device configured to respond at an optical frequency can be coupled to the port 308 of the metallic coupling structure 306, and the electrically variable impedance device can be adjustable via a control signal. That is, its impedance can be adjusted, and indeed, the nonlinearity of the impedance can also be adjusted; by changing the bias, one can “walk” the operating point up and down a curve, which is helpful for, e.g., detector applications. One example of such a device is a tunnel junction, such as the tunnel junction formed by the Ni layer 320 and the NiO barrier, configured to function as a modulator. The variable impedance can be an ordinary circuit impedance, or the variable wave impedance of an electro-optical material such as lithium niobate or electro-optic polymer, or the nonlinear wave impedance of a material such as beta-barium borate or potassium dihydrogen phosphate. Because of the very large field enhancement at the feed point compared with the interior of the waveguide, in one or more embodiments, nonlinear effects become strong at much lower incident power densities than in most devices

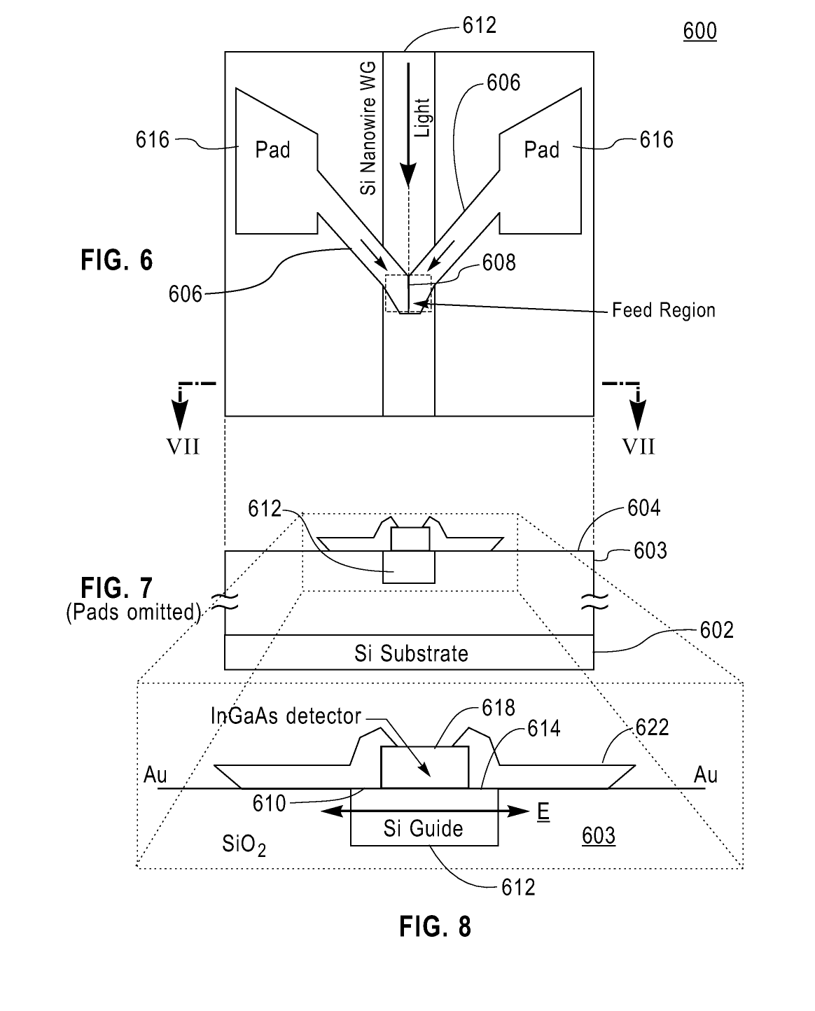

FIGS. 6-8 show an embodiment employing an Indium Gallium Arsenide (InGaAs) detector; elements similar to those in FIGS. 3-5 have received the same reference character incremented by three hundred. FIG. 6 shows a top view of the embodiment; FIG. 7 is a cross section of the device of FIG. 6 taken along line VII-VII thereof, and FIG. 8 is an enlarged view of FIG. 7. In lieu of the tunnel junction of FIGS. 3-5, an optical detector 618 is electrically connected to the port 608 of the metallic coupling structure 606, the optical detector 618 being configured to produce an electrical output responsive to an optical frequency signal present at the port 608. In the specific example depicted, the optical detector 618 is in the form of the aforementioned InGaAs detector, but other detectors could be used, for example, a Germanium detector or a Mercury Cadmium Telluride detector. In general, items in the different embodiments are only discussed in detail to the extent they materially differ from similar items described in earlier figures.

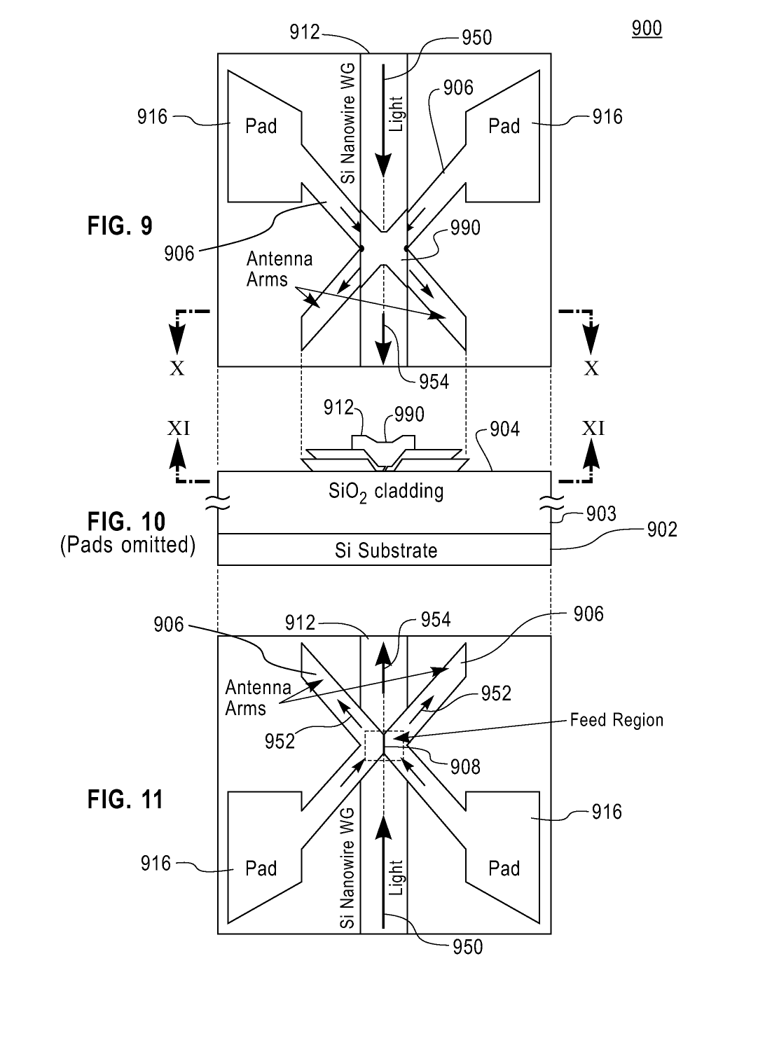

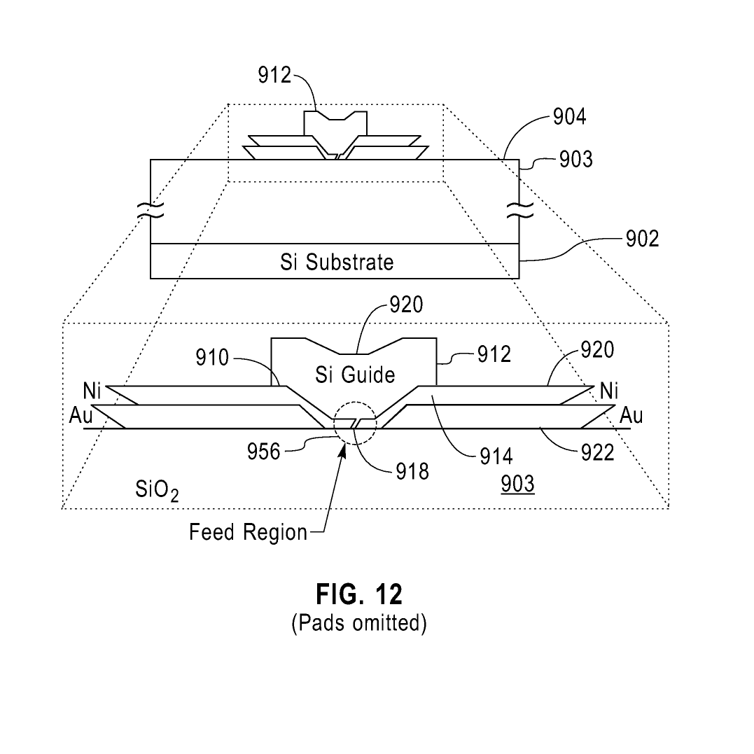

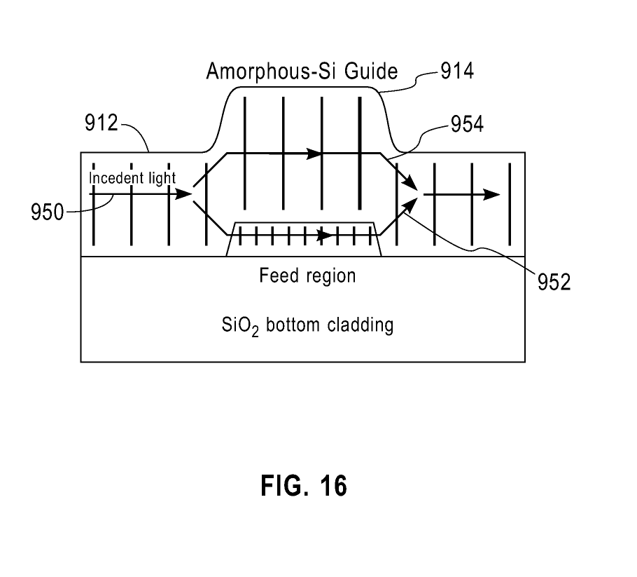

FIGS. 9-12 show an embodiment of an inventive Mach-Zehnder interferometer; elements similar to those in FIGS. 3-5 have received the same reference character incremented by six hundred FIG. 9 shows a top view of the embodiment; FIG. 10 is a cross section of the device of FIG. 9 taken along line X-X thereof, FIG. 11 is a bottom cross-sectional view of the device of FIGS. 9 and 10, taken along line XI-XI thereof; and FIG. 12 is an enlarged view of FIG. 10 with FIG. 10 reproduced therein for orientation purposes. Interferometer 900 includes a substrate 902 having a surface 904, a metallic coupling structure 906 deposited on the surface 904 of the substrate 902, the metallic coupling structure 906 comprising a feed region 908 and a waveguide interface portion 910. A dielectric waveguide 912 has a coupling interface portion or “jog” 914 deposited adjacent the waveguide interface portion 910 of the metallic coupling structure 906, the dielectric waveguide 912 being configured to split an incident wave 950 in the waveguide 912 into a first portion and a second portion, the first portion 952 being guided by the metallic coupling structure, the second portion 954 being guided by the coupling interface portion of the waveguide (the “jog”), the dielectric waveguide being miter configured to cause the first and second portions to recombine. The feed legion can comprise output terminals, such as tunnel junction feed region 956. Turning briefly to FIG. 16, the splitting and recombination are shown in detail, including elements 912, 914, 950, 952, and 954.

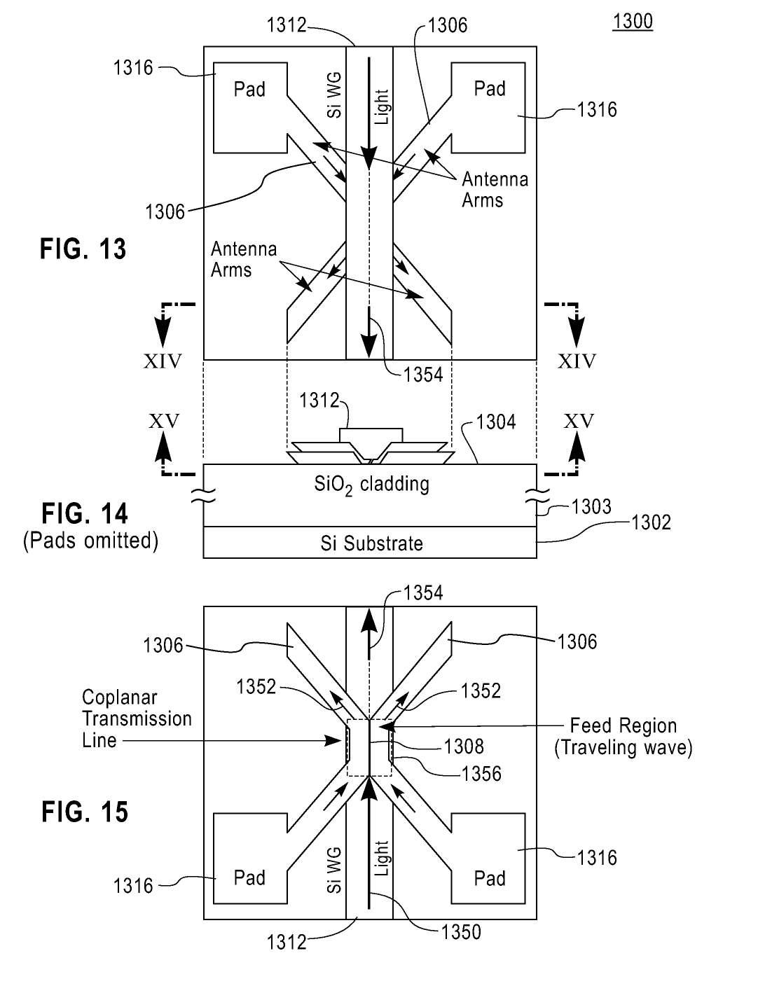

FIGS. 13-15 show a traveling wave embodiment otherwise similar to the interferometer of FIGS. 9-12; elements similar to those in FIGS. 9-12 have received the same reference character incremented by four hundred. FIG. 13 shows a top view of the embodiment; FIG. 14 is a cross section of the device of FIG. 13 taken along line XVI-XVI thereof and FIG. 15 is a bottom cross-sectional view of the device of FIGS. 13 and 14, taken along line XV-XV thereof. In this embodiment, the feed region 1356 comprises a coplanar metallic transmission line 1308.

An interferometer of the kind just described can be used to form a nonlinear optical device, in combination with an electro-optic material (as discussed above with respect to FIGS. 3-5) having a small-cross-section region with a cross-section smaller than the cross section of the dielectric waveguide, the electro-optic material being juxtaposed with the coplanar metallic transmission line so as to concentrate a portion of an incoming optical wave into the small-cross-section region.

The techniques set forth herein can be carried out, for example, via circuits and structures realized on an integrated circuit chip. The chip design can be created, e.g., in a graphical computer programming language, and stored in a computer storage medium (such as a disk, tape, physical hard drive, or virtual bard drive such as in a storage area network). If the designer does not fabricate chips or the photolithographic masks used to fabricate chips, the designer may transmit the resulting design by physical means (e.g., by providing a copy of the storage medium storing the design) or electronically (e.g., through the Internet) to such entities, directly or indirectly. The stored design can then be converted into an appropriate format such as, for example, Graphic Design System II (GDSII), for the fabrication of photolithographic masks, which typically include multiple copies of the chip design in question that are to be formed on a wafer. The photolithographic masks can be utilized to define areas of the wafer (and/or the layers thereon) to be etched or otherwise processed.

Resulting integrated circuit chips can be distributed by the fabricator in raw wafer form (that is, as a single wafer that has multiple unpackaged chips), as a bare die or in a packaged form. In the latter case, the chip can be mounted in a single chip package (such as a plastic carrier, with leads that are affixed to a mother board or other higher level carrier) or in a multi-chip package (such as a ceramic carrier that has either or both surface interconnections or buried interconnections). In any case, the chip may then be integrated with other chips, discrete circuit elements and/or other signal processing devices as part of either (a) an intermediate product, such as a mother board, or (b) an end product. The end product can be, for example, a high performance computer.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An optoelectric device comprising:
a substrate having a surface;
a metallic coupling structure deposited on said surface of said substrate, said metallic coupling structure having a port and a waveguide interface portion with at least two waveguide interlace portion sides; and
a dielectric waveguide, said dielectric waveguide having a coupling interface portion deposited adjacent to said at least two waveguide interface portion sides of said waveguide interface portion of said metallic coupling structure.

2. The device of claim 1, wherein said metallic coupling structure comprises an antenna and said port comprises a feed region of said antenna

3. The device of claim 1, further comprising a nonlinear electrical impedance device configured to respond at an optical frequency, said nonlinear electrical impedance device being coupled to said port of said metallic coupling structure.

4. The device of claim 3, wherein said nonlinear electrical impedance device comprises a tunnel junction.

5. The device of claim 1, further comprising an electrically variable impedance device configured to respond at an optical frequency, said electrically variable impedance device being coupled to said port of said metallic coupling structure, said electrically variable impedance device being configured to:
respond at an optical frequency; and
be adjustable via a control signal

6. The device of claim 5, wherein said electrically variable impedance device comprises a tunnel junction configured to function as a modulator.

7. The device of claim 1, further comprising an optical detector electrically connected to said port of said metallic coupling structure, said optical detector being configured to produce an electrical output responsive to an optical frequency signal present at said port.

8. The device of claim 7, wherein said optical detector comprises one of:
a Germanium detector;
an Indium Gallium Arsenide detector; and
a Mercury Cadmium Telluride detector.

9. The device of claim 1, wherein said dielectric waveguide comprises a core formed of a material having a refractive index greater than about 2.

10. The device of claim 9, wherein said material comprises Silicon.

11. The device of claim 1, wherein said dielectric waveguide comprises a core formed of a non-glass material.

12. An interferometer comprising:
a substrate having a surface;
a metallic coupling structure deposited on said surface of said substrate, said metallic coupling structure comprising a feed region and a waveguide interface portion with at least two waveguide interface portion sides; and
a dielectric waveguide, said dielectric waveguide having a coupling interface portion deposited adjacent to said at least two waveguide interface portion sides of said waveguide interface portion of said metallic coupling structure, said dielectric waveguide being configured to split an incident wave in said waveguide into a first portion and a second portion, said first portion being guided by said metallic coupling structure, said second portion being guided by said coupling interface portion of said waveguide, said dielectric waveguide being further configured to cause said first and second portions to recombine.

13. The interferometer of claim 12, wherein said feed region comprises output terminals.

14. The interferometer of claim 13, wherein said output terminals are formed as a tunnel junction feed region.

15. An interferometer comprising:
a substrate having a surface;
a metallic coupling structure deposited on said surface of said substrate, said metallic coupling structure comprising a coplanar metallic transmission line and a waveguide interface portion; and
a dielectric waveguide, said dielectric waveguide having a coupling interface portion deposited adjacent said waveguide interface portion of said metallic coupling structure, said dielectric waveguide being configured to split an incident wave in said waveguide into a first portion and a second portion, said first portion being guided by said metallic coupling structure, said second portion being guided by said coupling inter face portion of said waveguide, said dielectric waveguide being further configured to cause said first and second portions to recombine.

16. The interferometer of claim 15, wherein said waveguide interface portion has at least two waveguide interface portion sides and wherein said coupling interface portion is deposited adjacent to said at least two waveguide interface portion sides of said waveguide interface portion of said metallic coupling structure

17. A nonlinear optical device comprising:
an interferometer comprising:
a substrate having a surface;
a metallic coupling structure deposited on said surface of said substrate, said metallic coupling structure comprising a coplanar metallic transmission line having a waveguide interface portion; and
a dielectric waveguide, said dielectric waveguide having a cross-section and having a coupling interface portion deposited adjacent said waveguide interface portion of said metallic coupling structure, said dielectric waveguide being configured to split an incident wave in said waveguide into a first portion and a second portion, said first portion being guided by said coplanar metallic transmission line, said second portion being guided by said coupling interface portion of said waveguide, said dielectric waveguide being further configured to cause said first and second portions to recombine; and
an electro-optic material having a small-cross-section region with a cross-section smaller than said cross section of said dielectric waveguide, said electro-optic material being juxtaposed with said coplanar metallic transmission line so as to concentrate a portion of an incoming optical wave into said small-cross-section region
